(19) United States
(12) Patent Application Publication
(10) Pub. No.: US 2019/0147255 A1
(43) Pub. Date: May 16, 2019

(54) Systems and Methods for Generating Sparse Geographic Data for Autonomous Vehicles

(71) Applicant: Uber Technologies, Inc., San Francisco, CA (US)

(72) Inventors: Namdar Homayounfar, Toronto (CA); Wei-Chiu Ma, Toronto (CA); Shrinidhi Kowshika Lakshmikanth, Toronto (CA); Raquel Urtasun, Toronto (CA)

(21) Appl. No.: 16/123,343

(22) Filed: Sep. 6, 2018

Related U.S. Application Data
(60) Provisional application No. 62/586,770, filed on Nov. 15, 2017.

(51) Int. Cl. G06K 9/00; G05D 1/00; G01C 21/32; G01S 17/89; G06N 3/04; G06F 15/18

(52) U.S. Cl. CPC G06K 9/00798; G05D 1/0088; G01C 21/32; G05D 2201/0213; G06N 3/0454; G06F 15/18; G01S 17/89

(57) ABSTRACT

Systems and methods for generating sparse geographic data for autonomous vehicles are provided. In one example embodiment, a computing system can obtain sensor data associated with at least a portion of a surrounding environment of an autonomous vehicle. The computing system can identify a plurality of lane boundaries within the portion of the surrounding environment of the autonomous vehicle based at least in part on the sensor data and a first machine-learned model. The computing system can generate a plurality of polylines indicative of the plurality of lane boundaries based at least in part on a second machine-learned model. Each polyline of the plurality of polylines can be indicative of a lane boundary of the plurality of lane boundaries. The computing system can output a lane graph including the plurality of polylines.

### PRIORITY CLAIM

The present application is based on and claims priority to U.S. Provisional Application 62/586,770 having a filing date of Nov. 15, 2017, which is incorporated by reference herein.

### FIELD

The present disclosure relates generally to generating sparse geographic data for use by autonomous vehicles.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of generating lane graphs. The method includes obtaining, by a computing system including one or more computing devices, sensor data associated with at least a portion of a surrounding environment of an autonomous vehicle. The method includes identifying, by the computing system, a plurality of lane boundaries within the portion of the surrounding environment of the autonomous vehicle based at least in part on the sensor data and a first machine-learned model. The method includes generating, by the computing system, a plurality of polylines indicative of the plurality of lane boundaries based at least in part on a second machine-learned model. Each polyline of the plurality of polylines is indicative of a lane boundary of the plurality of lane boundaries. The method includes outputting, by the computing system, a lane graph associated with the portion of the surrounding environment of the autonomous vehicle. The lane graph includes the plurality of polylines that are indicative of the plurality of lane boundaries within the portion of the surrounding environment of the autonomous vehicle.

Another example aspect of the present disclosure is directed to a computing system. The computing system includes one or more processors and one or more tangible, non-transitory, computer readable media that collectively store instructions that when executed by the one or more processors cause the computing system to perform operations. The operations include obtaining sensor data associated with at least a portion of a surrounding environment of an autonomous vehicle. The operations include identifying a plurality of lane boundaries within the portion of the surrounding environment of the autonomous vehicle based at least in part on the sensor data. The operations include generating a plurality of polylines indicative of the plurality of lane boundaries based at least in part on a machine-learned lane boundary generation model. Each polyline of the plurality of polylines is indicative of a lane boundary of the plurality of lane boundaries. The operations include outputting a lane graph associated with the portion of the surrounding environment of the autonomous vehicle. The lane graph includes the plurality of polylines that are indicative of the plurality of lane boundaries within the portion of the surrounding environment of the autonomous vehicle.

Yet another example aspect of the present disclosure is directed to a computing system. The computing system includes one or more tangible, non-transitory computer-readable media that store a first machine-learned model that is configured to identify a plurality of lane boundaries within at least a portion of a surrounding environment of an autonomous vehicle based at least in part on input data associated with sensor data and to generate an output that is indicative of at least one region that is associated with a respective lane boundary of the plurality of lane boundaries and a second machine-learned model that is configured to generate a lane graph associated with the portion of the surrounding environment of the autonomous vehicle based at least in part on at least a portion of the output generated from the first machine-learned model. The lane graph includes a plurality of polylines indicative of the plurality of lane boundaries within the portion of the surrounding environment of the autonomous vehicle.

Other example aspects of the present disclosure are directed to systems, methods, vehicles, apparatuses, tangible, non-transitory computer-readable media, and memory devices for generating sparse geographic data.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system overview according to example embodiments of the present disclosure;

FIG. 2 depicts an example environment of a vehicle according to example embodiments of the present disclosure;

FIG. 3 depicts an example computing system according to example embodiments of the present disclosure;

FIGS. 4A-B depict diagrams of example sensor data according to example embodiments of the present disclosure;

FIG. 5 depicts a diagram of an example model architecture according to example embodiments of the present disclosure;

FIG. 6 depicts a diagram illustrating an example process for iterative lane graph generation according to example embodiments of the present disclosure;

FIG. 7 depicts a diagram of an example sparse geographic data according to example embodiments of the present disclosure;

FIG. 8 depicts a flow diagram of an example method for generating sparse geographic data according to example embodiments of the present disclosure; and

FIG. 9 depicts example system components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

The present disclosure is directed to systems and methods for iteratively generating sparse geographic data for autonomous vehicles. The geographic data can be, for example, lane graphs. A lane graph can represent a portion of a surrounding environment of an autonomous vehicle such as a travel way (e.g., a road, street, etc.). The lane graph can include data that is indicative of the lane boundaries within that portion of the environment. For example, the lane graph can include polyline(s) that estimate the position of the lane boundaries on the travel way. The lane boundaries can include, for example, lane markings and/or other indicia associated with a travel lane and/or travel way (e.g., the boundaries thereof).

For safe operation, it is important for autonomous vehicles to reliably understand where the lane boundaries of its surrounding environment are located. Accordingly, the present disclosure provides an improved approach for generating sparse geographic data (e.g., lane graphs) that can be utilized by an autonomous vehicle to identify the location of lane boundaries within its surrounding environment. For example, autonomous vehicles can obtain sensor data such as, for example, Light Detection and Ranging (LIDAR) data (e.g., via its onboard LIDAR system). This sensor data can depict at least a portion of the vehicle's surrounding environment. The computing systems and methods of the present disclosure can leverage this sensor data and machine-learned model(s) (e.g., neural networks, etc.) to identify the number of lane boundaries within the surrounding environment and the regions in which each lane boundary is located. Moreover, machine-learned model(s) can be utilized to iteratively generate polylines indicative of the lane boundaries in order to create a lane graph. For example, a computing system (e.g., including a hierarchical recurrent network) can sequentially produce a distribution over the initial regions of the lane boundaries, attend to them, and then generate a polyline over a chosen lane boundary by outputting a sequence of vertices. The computing system can generate a lane graph by iterating this process until all the identified lane boundaries are represented by polylines. Ultimately, an autonomous vehicle can utilize such a lane graph to perform various autonomy actions (e.g., vehicle localization, object perception, object motion prediction, motion planning, etc.), without having to rely on detailed, high-definition mapping data that can cause processing latency and constrain bandwidth resources.

More particularly, an autonomous vehicle can be a ground-based autonomous vehicle (e.g., car, truck, bus, etc.) or another type of vehicle (e.g., aerial vehicle) that can operate with minimal and/or no interaction from a human operator. An autonomous vehicle can include a vehicle computing system located onboard the autonomous vehicle to help control the autonomous vehicle. The vehicle computing system can be located onboard the autonomous vehicle, in that the vehicle computing system can be located on or within the autonomous vehicle. The vehicle computing system can include one or more sensors (e.g., cameras, Light Detection and Ranging (LIDAR), Radio Detection and Ranging (RADAR), etc.), an autonomy computing system (e.g., for determining autonomous navigation), one or more vehicle control systems (e.g., for controlling braking, steering, powertrain, etc.), and/or other systems. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment.

According to aspects of the present disclosure, a computing system can be configured to generate a lane graph for use by an autonomous vehicle and/or other systems. In some implementations, this computing system can be located onboard the autonomous vehicle (e.g., as a portion of the vehicle computing system). In some implementations, this computing system can be located at a location that is remote from the autonomous vehicle (e.g., as a portion of a remote operations computing system). The autonomous vehicle and such a remote computing system can communicate via one or more wireless networks.

To help create sparse geographic data (e.g., a lane graph), the computing system can obtain sensor data associated with at least a portion of a surrounding environment of an autonomous vehicle. The sensor data can include LIDAR data associated with the surrounding environment of the autonomous vehicle. The LIDAR data can be captured via a roof-mounted LIDAR system of the autonomous vehicle. The LIDAR data can be indicative of a LIDAR point cloud associated with the surrounding environment of the autonomous vehicle (e.g., created by LIDAR sweep(s) of the vehicle's LIDAR system). The computing system can project the LIDAR point cloud into a two-dimensional overhead view image (e.g., bird's eye view image with a resolution of 960×960 at a 5 cm per pixel resolution). The rasterized overhead view image can depict at least a portion of the surrounding environment of the autonomous vehicle (e.g., a 48 m by 48 m area with the vehicle at the center bottom of the image).

The computing system can identify a plurality of lane boundaries within the portion of the surrounding environment of the autonomous vehicle based at least in part on the sensor data. To do so, the computing system can include, employ, and/or otherwise leverage one or more first machine-learned model(s) such as, for example, a lane boundary detection model. The lane boundary detection model can be or can otherwise include one or more various model(s) such as, for example, neural networks (e.g., recurrent neural networks). The neural networks can include, for example, convolutional recurrent neural network(s). The machine-learned lane boundary detection model can be configured to identify a number of lane boundaries within the portion of the surrounding environment based at least in part on input data associated with the sensor data, as further described herein. Moreover, the machine-learned lane boundary detection model can be configured to generate an output that is indicative of one or more regions associated with the identified lane boundaries.

For instance, the computing system can input a first set of input data into the machine-learned lane boundary detection model. The first set of input data can be associated with the sensor data. For example, the computing system can include a feature pyramid network with a residual encoder-decoder architecture. The encoder-decoder architecture can include lateral additive connections that can be used to build features at different scales. The features of the encoder can capture information about the location of the lane boundaries at different scales. The decoder can be composed of multiple convolution and bilinear upsampling modules that build a feature map. The encoder can generate a feature map based at least in part on the sensor data (e.g., the LIDAR data). The feature map of the encoder can be provided as input into the machine-learned lane boundary detection model, which can concatenate the feature maps of the encoder (e.g., to obtain lane boundary location clues at different granularities). The machine-learned lane boundary detection model can include convolution layers with large non-overlapping receptive fields to downsample some feature map(s) (e.g., larger feature maps) and use bilinear upsampling for other feature map(s) (e.g., for the smaller feature maps) to bring them to the same resolution. A feature map can be fed to residual block(s) (e.g., two residual blocks) in order to obtain a final feature map of smaller resolution than the sensor data (e.g., LIDAR point cloud data) provided as input to the encoder. The machine-learned lane boundary detection model can include a convolutional recurrent neural network that can be iteratively applied to this feature map with the task of attending to the regions of the sensor data.

A loss function can be used to train the machine-learned lane boundary detection model. For instance, to train this model, a cross entropy loss can be applied to a region softmax output and a binary cross entropy loss can be applied on a halting probability. The ground truth for the regions can be bins in which an initial vertex of a lane boundary falls. The ground truth bins can be presented to the loss function in a particular order such as, for example, from the left of an overhead view LIDAR image to the right of the LIDAR image. For the binary cross entropy, the ground truth can be equal to one for each lane boundary and zero when it is time to stop counting the lane boundaries (e.g., in a particular overhead view LIDAR image depicting a portion of an environment of a vehicle). Additionally, or alternatively, other techniques can be utilized to train the machine-learned lane boundary detection model.

The computing system can obtain a first output from the machine-learned lane boundary detection model (e.g., the convolutional recurrent neural network) that is indicative of the region(s) associated with the identified lane boundaries. These regions can correspond to non-overlapping bins that are obtained by dividing the sensor data (e.g., an overhead view LIDAR point cloud image) into a plurality of segments along each spatial dimension. The output of the machine-learned lane boundary detection model can include, for example, the starting region of a lane boundary.

The computing system can iteratively generate a plurality of indicia to represent the lane boundaries of the surrounding environment within the sparse geographic data (e.g., on a lane graph). To do so, the computing system can include, employ, and/or otherwise leverage one or more second machine-learned model(s) such as, for example, a lane boundary generation model. The lane boundary generation model can be or can otherwise include one or more various model(s) such as, for example, neural networks (e.g., recurrent neural networks). The neural networks can include, for example, convolutional long short-term memory recurrent neural network(s). The machine-learned lane boundary generation model can be configured to iteratively generate indicia that represent lane boundaries (e.g., a plurality of polylines) based at least in part on the output generated by the machine-learned lane boundary detection model (or at least a portion thereof).

For instance, the computing system can input a second set of input data into the machine-learned lane boundary generation model. The second set of input data can include, for example, at least a portion of the data produced as output from the machine-learned lane boundary detection model. For instance, the second set of input data can be indicative of a first region associated with a first lane boundary. The first region can include a starting vertex of the first lane boundary. A section of this region can be cropped from the feature map of the decoder (described herein) and provided as input into the machine-learned lane boundary generation model (e.g., the convolutional long short-term memory recurrent neural network). The machine-learned lane boundary generation model can produce a softmax over the position of the next vertex on the lane boundary. The next vertex can then be used to crop out the next region and the process can continue until a polyline is fully generated and/or the end of the sensor data is reached (e.g., the boundary of the overhead view LIDAR image). As used herein, a polyline can be a representation of a lane boundary. A polyline can include a line (e.g., continuous line, broken line, etc.) that includes one or more segments. A polyline can include a plurality of points such as, for example, a sequence of vertices. In some implementations, the vertices can be connected by the one or more segments. In some implementations, the sequence of vertices may not be connected by the one or more segments.

Once the machine-learned lane boundary generation model finishes generating the first polyline for the first lane boundary, it can continue to iteratively generate one or more other polylines for one or more other lane boundaries. For instance, the second set of input data can include a second region associated with a second lane boundary. The second region can include a starting vertex for a second polyline. In a similar manner to the previously generated polyline, a section of this second region can be cropped from the feature map of the decoder and provided as input into the machine-learned lane boundary generation model. The machine-learned lane boundary generation model can produce a softmax over the position of the next vertex on the second lane boundary and the next vertex can be used to crop out the next region. This process can continue until a second polyline indicative of the second lane boundary is fully generated (and/or the end of the image data is reached). The machine-learned lane boundary generation model can continue until polylines are generated for all of the lane boundaries identified by the machine-learned lane boundary detection model. In this way, the machine-learned lane boundary generation model can create and output sparse geographic data (e.g., a lane graph) that includes the generated polylines.

The machine-learned lane boundary generation model can be trained based at least in part on a loss function. For instance, the machine-learned lane boundary generation model can be trained based at least in part on a loss function that penalizes the difference between two polylines (e.g., a ground truth polyline and a training polyline that is predicted by the model). The machine-learned lane boundary generation model can be penalized on the deviations of the two polylines. More particularly, the loss function can include two terms (e.g., two symmetric terms). The first term can encourage the training polyline that is predicted by the model to lie on, follow, match, etc. the ground truth polyline by summing and penalizing the deviation of the edge pixels of the predicted training polyline from those of the ground truth polyline. The second term can penalize the deviations of the ground truth polyline from the predicted training polyline. In this way, the machine-learned lane boundary generation model can be supervised during training to accurately generate polylines. Additionally, or alternatively, other techniques can be utilized to train the machine-learned lane boundary generation model.

The computing system can output sparse geographic data (e.g., a lane graph) associated with the portion of the surrounding environment of the autonomous vehicle. As described herein, the sparse geographic data (e.g., the lane graph) can include the plurality of polylines that are indicative of the plurality of lane boundaries within the portion of the surrounding environment of the autonomous vehicle (e.g., the portion depicted in the overhead view LIDAR data). The sparse geographic data (e.g., the lane graph) can be outputted to a memory that is local to and/or remote from the computing system (e.g., onboard the vehicle, remote from the vehicle, etc.). In some implementations, the sparse geographic data (e.g., the lane graph) can be outputted to one or more systems that are remote from an autonomous vehicle such as, for example, a mapping database that maintains map data to be utilized by one or more autonomous vehicles. In some implementations, the sparse geographic data (e.g., the lane graph) can be output to one or more systems onboard the autonomous vehicle (e.g., positioning system, autonomy system, etc.).

An autonomous vehicle can be configured to perform one or more vehicle actions based at least in part on the sparse geographic data. For example, the autonomous vehicle can localize itself within its surrounding environment based on a lane graph. The autonomous vehicle (e.g., a positioning system) can be configured to determine a location of the autonomous vehicle (e.g., within a travel lane on a highway) based at least in part on the one or more polylines of a lane graph. Additionally, or alternatively, the autonomous vehicle (e.g., a perception system) can be configured to perceive an object within the surrounding environment based at least in part on a lane graph. For example, a lane graph can help the vehicle computing system determine that an object is more likely a vehicle than any other type of object because a vehicle is more likely to be within the travel lane (between certain polylines) on a highway (e.g., than a bicycle, pedestrian, etc.). Additionally, or alternatively, an autonomous vehicle (e.g., a prediction system) can be configured to predict a motion trajectory of an object within the surrounding environment of the autonomous vehicle based at least in part on a lane graph. For example, an autonomous vehicle can predict that another vehicle is more likely to travel in a manner such that the vehicle stays between the lane boundaries represented by the polylines. Additionally, or alternatively, an autonomous vehicle (e.g., a motion planning system) can be configured to plan a motion of the autonomous vehicle based at least in part on a lane graph. For example, the autonomous vehicle can generate a motion plan by which the autonomous vehicle is to travel between the lane boundaries indicated by the polylines, queue for another object within a travel lane, pass an object outside of a travel lane, etc.

The systems and methods described herein provide a number of technical effects and benefits. For instance, the systems and methods of present disclosure provide an improved approach to producing sparse geographic data such as, for example, lane graphs. In accordance with aspects of the present disclosure the lane graphs can be produced in a more cost-effective and computationally efficient manner than high definition mapping data. Moreover, these systems and methods provide a more scalable solution (e.g., than detailed high definition maps) that would still allow a vehicle to accurately identify the lane boundaries within its surrounding environment. Accordingly, the autonomous vehicle can still confidently perform a variety of vehicle actions (e.g., localization, object perception, object motion prediction, motion planning, etc.) without relying on high definition map data. This can lead to a decrease in computational latency onboard the autonomous vehicle, a reduction in the bandwidth required for transmitting such data (e.g., across wireless networks), as well as a savings in the amount of onboard and off-board memory resources needed to store such data (rather than high-definition data).

The systems and methods of the present disclosure also provide an improvement to vehicle computing technology, such as autonomous vehicle related computing technology. For instance, the systems and methods of the present disclosure leverage machine-learned models and the sensor data acquired by autonomous vehicles to more accurately generate sparse geographic data that can be utilized by autonomous vehicles. For example, a computing system can obtain sensor data associated with at least a portion of a surrounding environment of an autonomous vehicle. The computing system can identify a plurality of lane boundaries within the portion of the surrounding environment of the autonomous vehicle based at least in part on the sensor data and a first machine-learned model (e.g., a machine-learned lane boundary detection model). The computing system can iteratively generate a plurality of polylines indicative of the plurality of lane boundaries based at least in part on a second machine-learned model (e.g., a machine-learned lane boundary generation model). As described herein, each polyline can be indicative of a lane boundary. The computing system can output sparse geographic data (e.g., a lane graph) associated with the portion of the surrounding environment of the autonomous vehicle. The sparse geographic data (e.g., the lane graph) can be a structured representation that includes the plurality of polylines that are indicative of the lane boundaries within the portion of the surrounding environment of the autonomous vehicle. In this way, the computing system can utilize machine-learned models to more efficiently and accurately count the lane boundaries, attend to the regions where the lane boundaries begin, and then generate indicia of the lane boundaries in an iterative and accurate manner. The machine-learned models are configured to accurately perform these tasks by training the models using a loss function that directly penalizes the deviations between polylines and the position of lane boundaries. According, the computing system can output a structured representation of a vehicle's surrounding environment that is topologically correct and thus is amenable to existing motion planners and other vehicle systems. As described herein, the sparse geographic data generated herein can allow an autonomous vehicle to confidently perform various actions with less onboard computational latency.

Although the present disclosure is discussed with particular reference to autonomous vehicles and lane graphs, the systems and methods described herein are applicable to the use of machine-learned models for other purposes. For example, the techniques described herein can be implemented and utilized by other computing systems such as, for example, user devices, robotic systems, non-autonomous vehicle systems, etc. to generate sparse data indicative of other types of markings (e.g., boundaries of walkways, buildings, etc.). Further, although the present disclosure is discussed with particular reference to certain networks, the systems and methods described herein can also be used in conjunction with many different forms of machine-learned models in addition or alternatively to those described herein. The reference to implementations of the present disclosure with respect to an autonomous vehicle is meant to be presented by way of example and is not meant to be limiting.

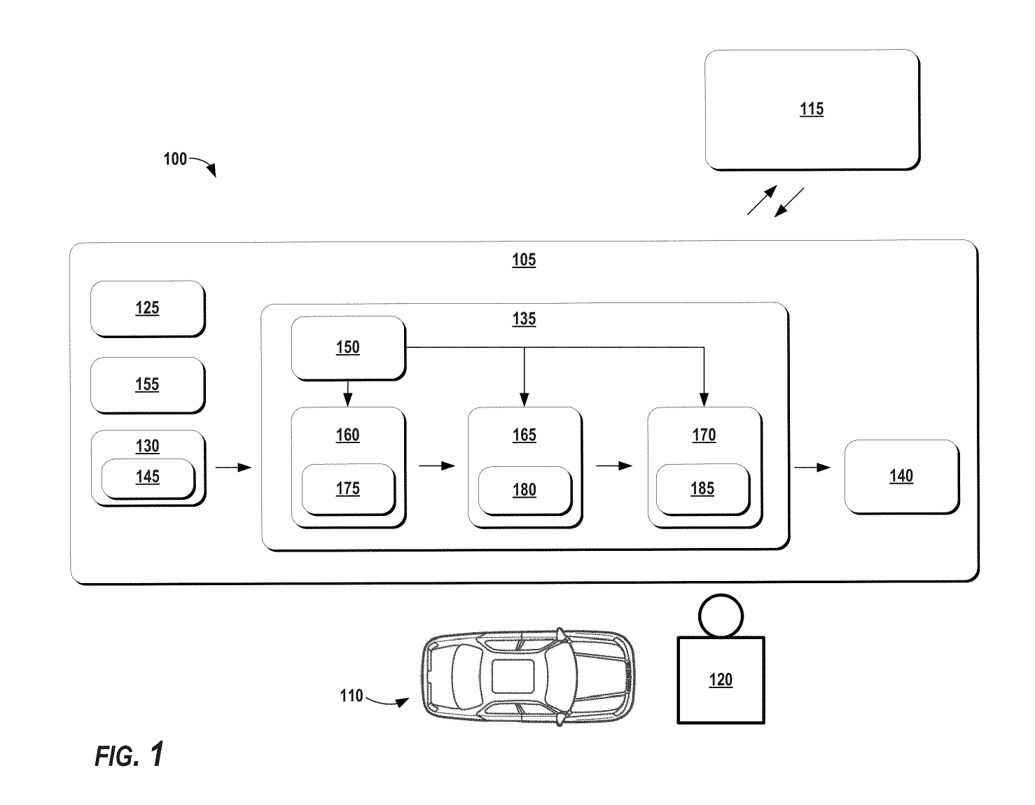

With reference now to the FIGS., example embodiments of the present disclosure will be discussed in further detail. FIG. 1 illustrates an example system 100 according to example embodiments of the present disclosure. The system 100 can include a vehicle computing system 105 associated with a vehicle 110. The system 100 can include an operations computing system 115 that is remote from the vehicle 110.

In some implementations, the vehicle 110 can be associated with an entity (e.g., a service provider, owner, manager). The entity can be one that offers one or more vehicle service(s) to a plurality of users via a fleet of vehicles that includes, for example, the vehicle 110. In some implementations, the entity can be associated with only vehicle 110 (e.g., a sole owner, manager). In some implementations, the operations computing system 115 can be associated with the entity. The vehicle 110 can be configured to provide one or more vehicle services to one or more users 120. The vehicle service(s) can include transportation services (e.g., rideshare services in which user rides in the vehicle 110 to be transported), courier services, delivery services, and/or other types of services. The vehicle service(s) can be offered to the users 120 by the entity, for example, via a software application (e.g., a mobile phone software application). The entity can utilize the operations computing system 115 to coordinate and/or manage the vehicle 110 (and its associated fleet, if any) to provide the vehicle services to a user 120.

The operations computing system 115 can include one or more computing devices that are remote from the vehicle 110 (e.g., located off-board the vehicle 110). For example, such computing device(s) can be components of a cloud-based server system and/or other type of computing system that can communicate with the vehicle computing system 105 of the vehicle 110 (and/or a user device). The computing device(s) of the operations computing system 115 can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system 115 (e.g., the one or more processors, etc.) to perform operations and functions, such as providing data to and/or obtaining data from the vehicle 110, for managing a fleet of vehicles (that includes the vehicle 110), etc.

The vehicle 110 incorporating the vehicle computing system 105 can be various types of vehicles. For instance, the vehicle 110 can be a ground-based autonomous vehicle such as an autonomous truck, autonomous car, autonomous bus, etc. The vehicle 110 can be an air-based autonomous vehicle (e.g., airplane, helicopter, or other aircraft) or other types of vehicles (e.g., watercraft, etc.). The vehicle 110 can be an autonomous vehicle that can drive, navigate, operate, etc. with minimal and/or no interaction from a human operator (e.g., driver). In some implementations, a human operator can be omitted from the vehicle 110 (and/or also omitted from remote control of the vehicle 110). In some implementations, a human operator can be included in the vehicle 110. In some implementations, the vehicle 110 can be a non-autonomous vehicle (e.g., ground-based, air-based, water-based, other vehicles, etc.).

In some implementations, the vehicle 110 can be configured to operate in a plurality of operating modes. The vehicle 110 can be configured to operate in a fully autonomous (e.g., self-driving) operating mode in which the vehicle 110 is controllable without user input (e.g., can drive and navigate with no input from a human operator present in the vehicle 110 and/or remote from the vehicle 110). The vehicle 110 can operate in a semi-autonomous operating mode in which the vehicle 110 can operate with some input from a human operator present in the vehicle 110 (and/or a human operator that is remote from the vehicle 110). The vehicle 110 can enter into a manual operating mode in which the vehicle 110 is fully controllable by a human operator (e.g., human driver, pilot, etc.) and can be prohibited and/or disabled (e.g., temporary, permanently, etc.) from performing autonomous navigation (e.g., autonomous driving). In some implementations, the vehicle 110 can implement vehicle operating assistance technology (e.g., collision mitigation system, power assist steering, etc.) while in the manual operating mode to help assist the human operator of the vehicle 110.

The operating modes of the vehicle 110 can be stored in a memory onboard the vehicle 110. For example, the operating modes can be defined by an operating mode data structure (e.g., rule, list, table, etc.) that indicates one or more operating parameters for the vehicle 110, while in the particular operating mode. For example, an operating mode data structure can indicate that the vehicle 110 is to autonomously plan its motion when in the fully autonomous operating mode. The vehicle computing system 105 can access the memory when implementing an operating mode.

The operating mode of the vehicle 110 can be adjusted in a variety of manners. For example, the operating mode of the vehicle 110 can be selected remotely, off-board the vehicle 110. For example, an entity associated with the vehicle 110 (e.g., a service provider) can utilize the operations computing system 115 to manage the vehicle 110 (and/or an associated fleet). The operations computing system 115 can send data to the vehicle 110 instructing the vehicle 110 to enter into, exit from, maintain, etc. an operating mode. By way of example, the operations computing system 115 can send data to the vehicle 110 instructing the vehicle 110 to enter into the fully autonomous operating mode. In some implementations, the operating mode of the vehicle 110 can be set onboard and/or near the vehicle 110. For example, the vehicle computing system 105 can automatically determine when and where the vehicle 110 is to enter, change, maintain, etc. a particular operating mode (e.g., without user input). Additionally, or alternatively, the operating mode of the vehicle 110 can be manually selected via one or more interfaces located onboard the vehicle 110 (e.g., key switch, button, etc.) and/or associated with a computing device proximate to the vehicle 110 (e.g., a tablet operated by authorized personnel located near the vehicle 110). In some implementations, the operating mode of the vehicle 110 can be adjusted by manipulating a series of interfaces in a particular order to cause the vehicle 110 to enter into a particular operating mode.

The vehicle computing system 105 can include one or more computing devices located onboard the vehicle 110. For example, the computing device(s) can be located on and/or within the vehicle 110. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the vehicle 110 (e.g., its computing system, one or more processors, etc.) to perform operations and functions, such as those described herein for controlling the operation of the vehicle 110, initiating vehicle action(s), generating sparse geographic data, etc.

The vehicle 110 can include a communications system 125 configured to allow the vehicle computing system 105 (and its computing device(s)) to communicate with other computing devices. The vehicle computing system 105 can use the communications system 125 to communicate with the operations computing system 115 and/or one or more other computing device(s) over one or more networks (e.g., via one or more wireless signal connections). In some implementations, the communications system 125 can allow communication among one or more of the system(s) on-board the vehicle 110. The communications system 125 can include any suitable components for interfacing with one or more network(s), including, for example, transmitters, receivers, ports, controllers, antennas, and/or other suitable components that can help facilitate communication.

As shown in FIG. 1, the vehicle 110 can include one or more vehicle sensors 130, an autonomy computing system 135, one or more vehicle control systems 140, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

The vehicle sensor(s) 130 can be configured to acquire sensor data 145. This can include sensor data associated with the surrounding environment of the vehicle 110. For instance, the sensor data 145 can acquire image and/or other data within a field of view of one or more of the vehicle sensor(s) 130. The vehicle sensor(s) 130 can include a Light Detection and Ranging (LIDAR) system, a Radio Detection and Ranging (RADAR) system, one or more cameras (e.g., visible spectrum cameras, infrared cameras, etc.), motion sensors, and/or other types of imaging capture devices and/or sensors. The sensor data 145 can include image data, radar data, LIDAR data, and/or other data acquired by the vehicle sensor(s) 130. The vehicle 110 can also include other sensors configured to acquire data associated with the vehicle 110. For example, the vehicle can include inertial measurement unit(s), wheel odometry devices, and/or other sensors that can acquire data indicative of a past, present, and/or future state of the vehicle 110.

In some implementations, the sensor data 145 can be indicative of one or more objects within the surrounding environment of the vehicle 110. The object(s) can include, for example, vehicles, pedestrians, bicycles, and/or other objects. The object(s) can be located in front of, to the rear of, to the side of the vehicle 110, etc. The sensor data 145 can be indicative of locations associated with the object(s) within the surrounding environment of the vehicle 110 at one or more times. The vehicle sensor(s) 130 can provide the sensor data 145 to the autonomy computing system 135.

In addition to the sensor data 145, the autonomy computing system 135 can retrieve or otherwise obtain map data 150. The map data 150 can provide information about the surrounding environment of the vehicle 110. In some implementations, a vehicle 110 can obtain detailed map data that provides information regarding: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the vehicle 110 in comprehending and perceiving its surrounding environment and its relationship thereto. Additionally, or alternatively, the map data 150 can include sparse geographic data that includes, for example, only indicia of the boundaries of the geographic area (e.g., lane graphs), as described herein. In some implementations, the vehicle computing system 105 can determine a vehicle route for the vehicle 110 based at least in part on the map data 150.

The vehicle 110 can include a positioning system 155. The positioning system 155 can determine a current position of the vehicle 110. The positioning system 155 can be any device or circuitry for analyzing the position of the vehicle 110. For example, the positioning system 155 can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.) and/or other suitable techniques. The position of the vehicle 110 can be used by various systems of the vehicle computing system 105 and/or provided to a remote computing device (e.g., of the operations computing system 115). For example, the map data 150 can provide the vehicle 110 relative positions of the surrounding environment of the vehicle 104. The vehicle 110 can identify its position within the surrounding environment (e.g., across six axes) based at least in part on the data described herein. For example, the vehicle 110 can process the sensor data 145 (e.g., LIDAR data, camera data) to match it to a map of the surrounding environment to get an understanding of the vehicle's position within that environment.

The autonomy computing system 135 can include a perception system 160, a prediction system 165, a motion planning system 170, and/or other systems that cooperate to perceive the surrounding environment of the vehicle 110 and determine a motion plan for controlling the motion of the vehicle 110 accordingly. For example, the autonomy computing system 135 can obtain the sensor data 145 from the vehicle sensor(s) 130, process the sensor data 145 (and/or other data) to perceive its surrounding environment, predict the motion of objects within the surrounding environment, and generate an appropriate motion plan through such surrounding environment. The autonomy computing system 135 can communicate with the one or more vehicle control systems 140 to operate the vehicle 110 according to the motion plan.

The vehicle computing system 105 (e.g., the autonomy system 135) can identify one or more objects that are proximate to the vehicle 110 based at least in part on the sensor data 145 and/or the map data 150. For example, the vehicle computing system 105 (e.g., the perception system 160) can process the sensor data 145, the map data 150, etc. to obtain perception data 175. The vehicle computing system 105 can generate perception data 175 that is indicative of one or more states (e.g., current and/or past state(s)) of a plurality of objects that are within a surrounding environment of the vehicle 110. For example, the perception data 175 for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape); class (e.g., pedestrian class vs. vehicle class vs. bicycle class), the uncertainties associated therewith, and/or other state information. The perception system 160 can provide the perception data 175 to the prediction system 165 (and/or the motion planning system 170).

The prediction system 165 can be configured to predict a motion of the object(s) within the surrounding environment of the vehicle 110. For instance, the prediction system 165 can generate prediction data 180 associated with such object(s). The prediction data 180 can be indicative of one or more predicted future locations of each respective object. For example, the prediction system 180 can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 180 can be indicative of the speed and/or acceleration at which the respective object is predicted to travel along its associated predicted motion trajectory. The predictions system 165 can output the prediction data 180 (e.g., indicative of one or more of the predicted motion trajectories) to the motion planning system 170.

The vehicle computing system 105 (e.g., the motion planning system 170) can determine a motion plan 185 for the vehicle 110 based at least in part on the perception data 175, the prediction data 180, and/or other data. A motion plan 185 can include vehicle actions (e.g., planned vehicle trajectories, speed(s), acceleration(s), other actions, etc.) with respect to one or more of the objects within the surrounding environment of the vehicle 110 as well as the objects' predicted movements. For instance, the motion planning system 170 can implement an optimization algorithm, model, etc. that considers cost data associated with a vehicle action as well as other objective functions (e.g., cost functions based on speed limits, traffic lights, etc.), if any, to determine optimized variables that make up the motion plan 185. The motion planning system 170 can determine that the vehicle 110 can perform a certain action (e.g., pass an object) without increasing the potential risk to the vehicle 110 and/or violating any traffic laws (e.g., speed limits, lane boundaries, signage, etc.). For instance, the motion planning system 170 can evaluate one or more of the predicted motion trajectories of one or more objects during its cost data analysis as it determines an optimized vehicle trajectory through the surrounding environment. The motion planning system 185 can generate cost data associated with such trajectories. In some implementations, one or more of the predicted motion trajectories may not ultimately change the motion of the vehicle 110 (e.g., due to an overriding factor such as a jaywalking pedestrian). In some implementations, the motion plan 185 may define the vehicle's motion such that the vehicle 110 avoids the object(s), reduces speed to give more leeway to one or more of the object(s), proceeds cautiously, performs a stopping action, etc.

The motion planning system 170 can be configured to continuously update the vehicle's motion plan 185 and a corresponding planned vehicle motion trajectory. For example, in some implementations, the motion planning system 170 can generate new motion plan(s) 185 for the vehicle 110 (e.g., multiple times per second). Each new motion plan can describe a motion of the vehicle 110 over the next planning period (e.g., next several seconds). Moreover, a new motion plan may include a new planned vehicle motion trajectory. Thus, in some implementations, the motion planning system 170 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the vehicle 110.

The vehicle computing system 105 can cause the vehicle 110 to initiate a motion control in accordance with at least a portion of the motion plan 185. For instance, the motion plan 185 can be provided to the vehicle control system(s) 140 of the vehicle 110. The vehicle control system(s) 140 can be associated with a vehicle controller (e.g., including a vehicle interface) that is configured to implement the motion plan 185. The vehicle controller can, for example, translate the motion plan into instructions for the appropriate vehicle control component (e.g., acceleration control, brake control, steering control, etc.). By way of example, the vehicle controller can translate a determined motion plan 185 into instructions to adjust the steering of the vehicle 110 “X” degrees, apply a certain magnitude of braking force, etc. The vehicle controller (e.g., the vehicle interface) can help facilitate the responsible vehicle control (e.g., braking control system, steering control system, acceleration control system, etc.) to execute the instructions and implement the motion plan 185 (e.g., by sending control signal(s), making the translated plan available, etc.). This can allow the vehicle 110 to autonomously travel within the vehicle's surrounding environment.

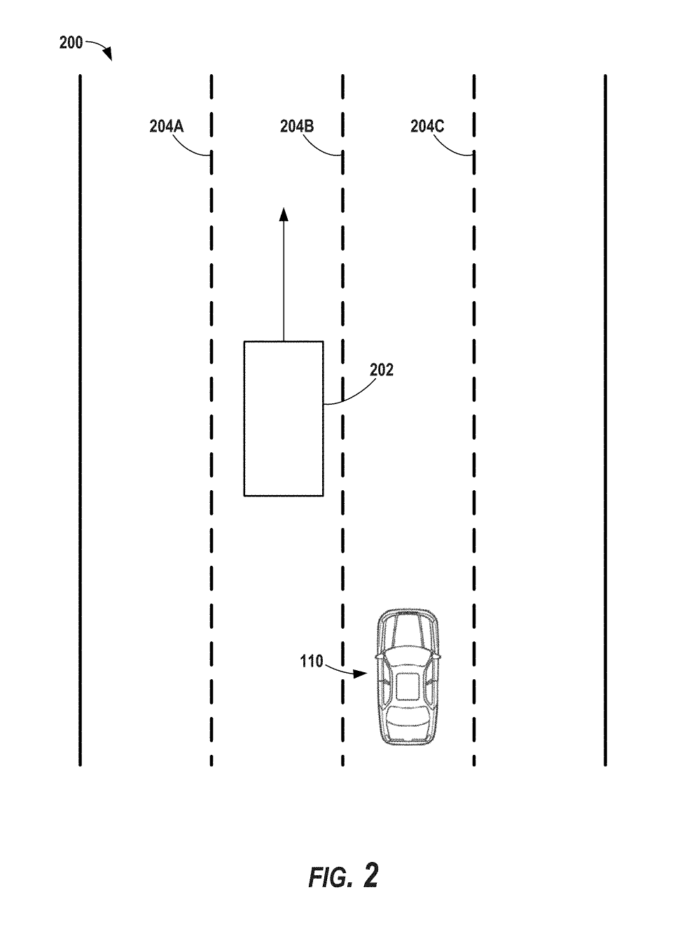

FIG. 2 depicts an example environment 200 of the vehicle 110 according to example embodiments of the present disclosure. The surrounding environment 200 of the vehicle 110 can be, for example, a highway environment, an urban environment, a residential environment, a rural environment, and/or other types of environments. The surrounding environment 200 can include one or more objects such as an object 202 (e.g., another vehicle, etc.). The surrounding environment 200 can include one or more lane boundaries 204A-C. As described herein, the lane boundaries 204A-C can include, for example, lane markings and/or other indicia associated with a travel lane and/or travel way (e.g., the boundaries thereof). For example, the one or more lane boundaries 204A-C can be located within a highway on which the vehicle 110 is located.

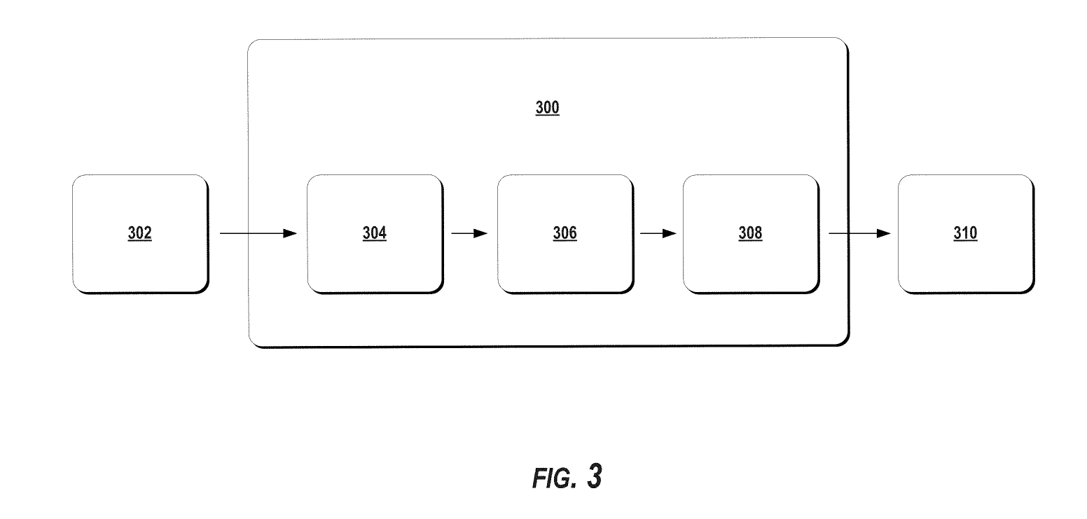

FIG. 3 depicts a diagram of an example computing system 300 that is configured to detect generate sparse geographic data for an environment of a vehicle such as, for example, the environment 200. In some implementations, the computing system 300 can be located onboard the vehicle 110 (e.g., as a portion of the vehicle computing system 105). Additionally, or alternatively, the computing system 300 may not be located on the vehicle 110. For example, one or more portions of the computing system 300 can be located at a location that is remote from the vehicle 110 (e.g., remote from the vehicle computing system 105, as a portion of the operations computing system 115, as another system, etc.).

The computing system 300 can include one or more computing devices. The computing devices can implement a model architecture for lane boundary identification and sparse geographic data (e.g., lane graph) generation, as further described herein. For example, the computing system 300 can include one or more processors and one or more tangible, non-transitory, computer readable media that collectively store instructions that when executed by the one or more processors cause the computing system 300 to perform operations such as, for example, those described herein for identifying lane boundaries within the surrounding environment 200 of the vehicle 110 and the generating sparse geographic data (e.g., lane graphs) associated therewith.

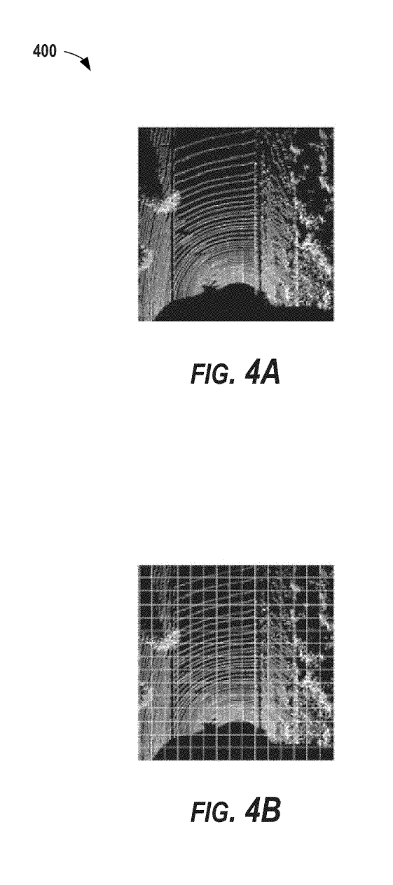

To help create sparse geographic data associated with the surrounding environment 200 of the vehicle 110, the computing system 300 can obtain sensor data associated with at least a portion of the surrounding environment 200 of the vehicle 110. As shown for example in FIG. 4A, the sensor data 400 can include LIDAR data associated with the surrounding environment 200 of the vehicle 110. The LIDAR data can be captured via a roof-mounted LIDAR system of the vehicle 110. The LIDAR data can be indicative of a LIDAR point cloud associated with the surrounding environment 200 of the vehicle 110 (e.g., created by LIDAR sweep(s) of the vehicle's LIDAR system). The computing system 300 can project the LIDAR point cloud into a two-dimensional overhead view image (e.g., bird's eye view image with a resolution of 960×960 at a 5 cm per pixel resolution). The rasterized overhead view image can depict at least a portion of the surrounding environment 200 of the vehicle 110 (e.g., a 48 m by 48 m area with the vehicle at the center bottom of the image). The LIDAR data can provide a sparse representation of at least a portion of the surrounding environment 200. In some implementations, the sensor data 302 can be indicative of one or more sensor modalities (e.g., encoded in one or more channels). This can include, for example, intensity (e.g., LIDAR intensity) and/or other sensor modalities. In some implementations, the sensor data can also, or alternatively, include other types of sensor data (e.g., motion sensor data, camera sensor data, RADAR sensor data, SONAR sensor data, etc.).

Returning to FIG. 3, the computing system 300 can identify a plurality of lane boundaries 204A-C within a portion of the surrounding environment 200 of the vehicle 110 based at least in part on the sensor data. To do so, the computing system 300 can include, employ, and/or otherwise leverage one or more first machine-learned model(s) 304 such as, for example, a machine-learned lane boundary detection model. The machine-learned lane boundary detection model can be or can otherwise include one or more various model(s) such as, for example, neural networks. The neural networks can include, for example, convolutional recurrent neural network(s). The machine-learned lane boundary detection model can be configured to identify a number of lane boundaries within the portion of the surrounding environment based at least in part on input data associated with the sensor data.

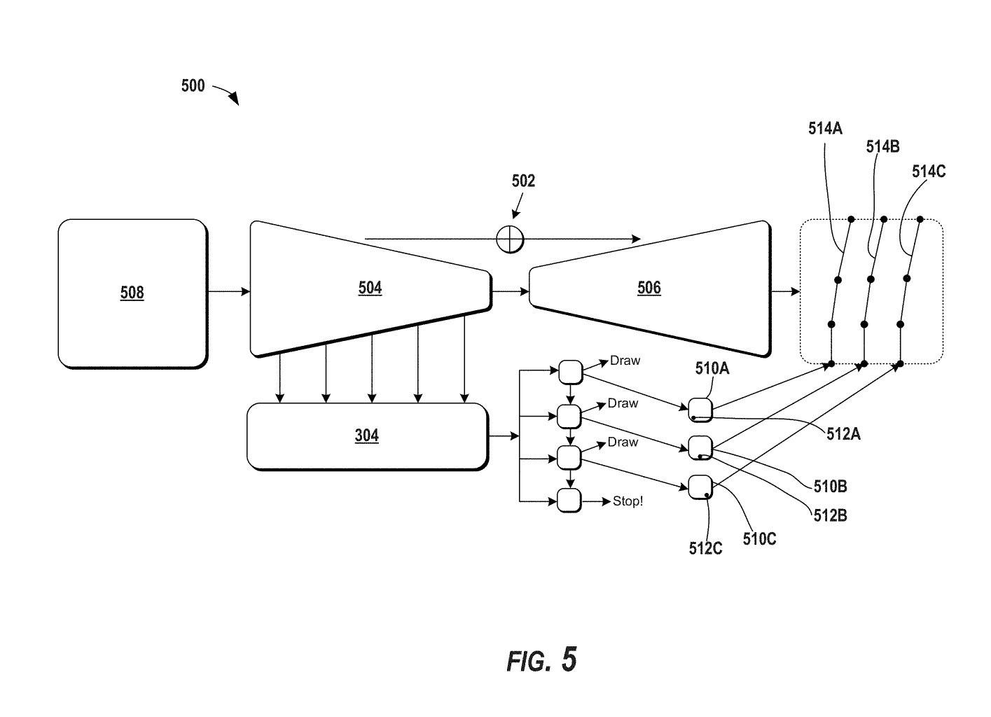

The computing system 300 can identify the plurality of lane boundaries 204A-C within a portion of the surrounding environment 200 of the vehicle 110 based at least in part on the first machine-learned model(s) 304 (e.g., a machine-learned lane boundary detection model). For instance, the computing system 300 can input a first set of input data 302 into the first machine-learned model(s) 304A (e.g., the machine-learned lane boundary detection model). The first set of input data 302 can be associated with the sensor data 400. For example, as shown in FIG. 5, the computing system 300 can include a model architecture 500. The model architecture can include a feature pyramid network with a residual encoder-decoder architecture. The encoder-decoder architecture can include lateral additive connections 502 that can be used to build features at different scales. The features of the encoder 504 can capture information about the location of the lane boundaries 204A-C at different scales. The decoder 506 can be composed of multiple convolution and bilinear upsampling modules that build a feature map. The encoder 504 can generate a feature map based at least in part on sensor data 508 (e.g., including sensor data 400, LIDAR data, etc.). The feature map of the encoder 504 can be provided as an input into the first machine-learned model(s) 304 (e.g., a machine-learned lane boundary detection model), which can concatenate the feature map of the encoder 504 (e.g., to obtain lane boundary location clues at different granularities). The first machine-learned model(s) 304 (e.g., a machine-learned lane boundary detection model) can include convolution layers with large non-overlapping receptive fields to downsample some feature map(s) (e.g., larger feature maps) and use bilinear upsampling for other feature map(s) (e.g., for the smaller feature maps) to bring them to the same resolution. A feature map can be fed to residual block(s) (e.g., two residual blocks) in order to obtain a final feature map of smaller resolution than the sensor data 508 (e.g., LIDAR point cloud data) provided as input to the encoder 504. This reduction of resolution can be possible as the subsequent models can be trained to focus on the regions where the lane boundaries start (e.g., rather than the exact starting coordinate).

The first machine-learned model(s) 304 (e.g., a machine-learned lane boundary detection model) can include a convolutional recurrent neural network that can be iteratively applied to this feature map with the task of attending to the regions of the sensor data 508. The first machine-learned model(s) 304 can continue until there are no more lane boundaries. In order to be able to stop, first machine-learned model(s) 304 (e.g., the recurrent neural network) can output a binary variable denoting whether all the lanes have already be counted or not. For example, at each time step t, the first machine-learned model(s) 304 (e.g., a machine-learned lane boundary detection model) can output a probability hₜ of halting and a softmax sₜ of dimension H/K×W/K×1 over the region of the starting vertex of the next lane boundary. At inference time, the softmax can be replaced with an argmax and the probability of halting can be thresholded.

Returning to FIG. 3, the computing system 300 can obtain a first output 306 from the first machine-learned model(s) 304 (e.g., the machine-learned lane boundary detection model) that is indicative of the region(s) associated with the identified lane boundaries. These regions can correspond to non-overlapping bins (e.g., discretized bins) that are obtained by dividing the sensor data (e.g., an overhead view LIDAR point cloud image) into a plurality of segments along each spatial dimension (e.g., as shown in FIG. 4B). The output 306 of the first machine-learned model(s) 304 (e.g., the machine-learned lane boundary detection model) can include, for example, the starting region of at least one lane boundary.

The computing system 300 can generate (e.g., iteratively generate) a plurality of indicia to represent the lane boundaries 204A-C of the surrounding environment 200 within sparse geographic data (e.g., on a lane graph). To do so, the computing system 300 can include, employ, and/or otherwise leverage one or more second machine-learned model(s) 308 such as, for example, a machine-learned lane boundary generation model. The machine-learned lane boundary generation model can be or can otherwise include one or more various model(s) such as, for example, neural networks (e.g., recurrent neural networks). The neural networks can include, for example, a machine-learned convolutional long short-term memory recurrent neural network(s). The machine-learned lane boundary generation model can be configured to iteratively generate indicia indicative of the plurality of lane boundaries 204A-C based at least in part on (at least a portion of) the output 306 generated by the first machine-learned model(s) 304 (e.g., the machine-learned lane boundary detection model). The indicia can include, for example, polylines associated with the lane boundaries, as further described herein.

As used herein, a polyline can be a representation of a lane boundary. A polyline can include a line (e.g., continuous line, broken line, etc.) that includes one or more segments. A polyline can include a plurality of points such as, for example, a sequence of vertices. In some implementations, the vertices can be connected by the one or more segments. In some implementations, the sequence of vertices may not be connected by the one or more segments.

The computing system 300 can generate indicia (e.g., a plurality of polylines) indicative of the plurality of lane boundaries 204A-C based at least in part on the second machine-learned model(s) 308 (e.g., a machine-learned lane boundary generation model). Each indicia (e.g., polyline of the plurality of polylines) can be indicative of a respective lane boundary 204A-C of the plurality of lane boundaries (e.g., counted by the first machine-learned model(s) 304). For instance, the computing system can input a second set of input data into the second machine-learned model(s) 308 (e.g., the machine-learned lane boundary generation model). The second set of input data can include, for example, at least a portion of the data produced as an output 306 from the first machine-learned model(s) 304 (e.g., the machine-learned lane boundary detection model).

For instance, with reference to FIG. 5, the second set of input data can be indicative of a first region 510A associated with a first lane boundary 204A. The first region 520A can include a starting vertex 512A of the first lane boundary 204A. The second machine-learned model(s) 308 (e.g., the convolutional long short-term memory recurrent neural network) can be configured to generate a first polyline 514A indicative of the first lane boundary 204A based at least in part on the first region 510A. For instance, a section of this region can be cropped from the feature map of the decoder 506 and provided as input into the second machine-learned model(s) 308 (e.g., the convolutional long short-term memory recurrent neural network). The second machine-learned model(s) 308 (e.g., machine-learned lane boundary generation model) can produce a softmax over the position of the next vertex on the lane boundary. The next vertex can then be used to crop out the next region and the process can continue until a first polyline 514A indicative of the first lane boundary 204A is fully generated and/or the end of the sensor data 508 is reached (e.g., the boundary of the overhead view LIDAR image).

Once the second machine-learned model(s) 308 (e.g., machine-learned lane boundary generation model) finish generating the first polyline 514A for the first lane boundary 204A, it can continue to iteratively generate one or more other polylines 514B-C for one or more other lane boundaries 204B-C. For instance, the second set of input data can include a second region 510B associated with a second lane boundary 204B. After completion of the first polyline 514A, the second machine-learned model(s) 308 (e.g., machine-learned lane boundary generation model) can generate a second polyline 514B indicative of the second lane boundary 204B based at least in part on a second region 510B. The second region 510B can include a starting vertex 512B for a second polyline 514B. In a similar manner to the previously generated polyline, a section of this second region 510B can be cropped from the feature map of the decoder 506 and provided as input into the second machine-learned model(s) 308 (e.g., the machine-learned lane boundary generation model). The second machine-learned model(s) 308 (e.g., the machine-learned lane boundary generation model) can produce a softmax over the position of the next vertex on the second lane boundary 204B and the next vertex can be used to crop out the next region. This process can continue until a second polyline 514B indicative of the second lane boundary 204B is fully generated (and/or the end of the image data is reached). The second machine-learned model(s) 308 (e.g., the machine-learned lane boundary generation model) can follow a similar process to generate a third polyline 514C indicative of a third lane boundary 204C based at least in part on a third region 510C (e.g., with a starting vertex 512C). The second machine-learned model(s) 308 (e.g., the machine-learned lane boundary generation model) can continue until polylines are generated for all of the lane boundaries identified by the first machine-learned model(s) 304 (e.g., the machine-learned lane boundary detection model). In this way, the computing system 300 can create and output sparse geographic data (e.g., a lane graph) that includes the generated polylines 514A-C.

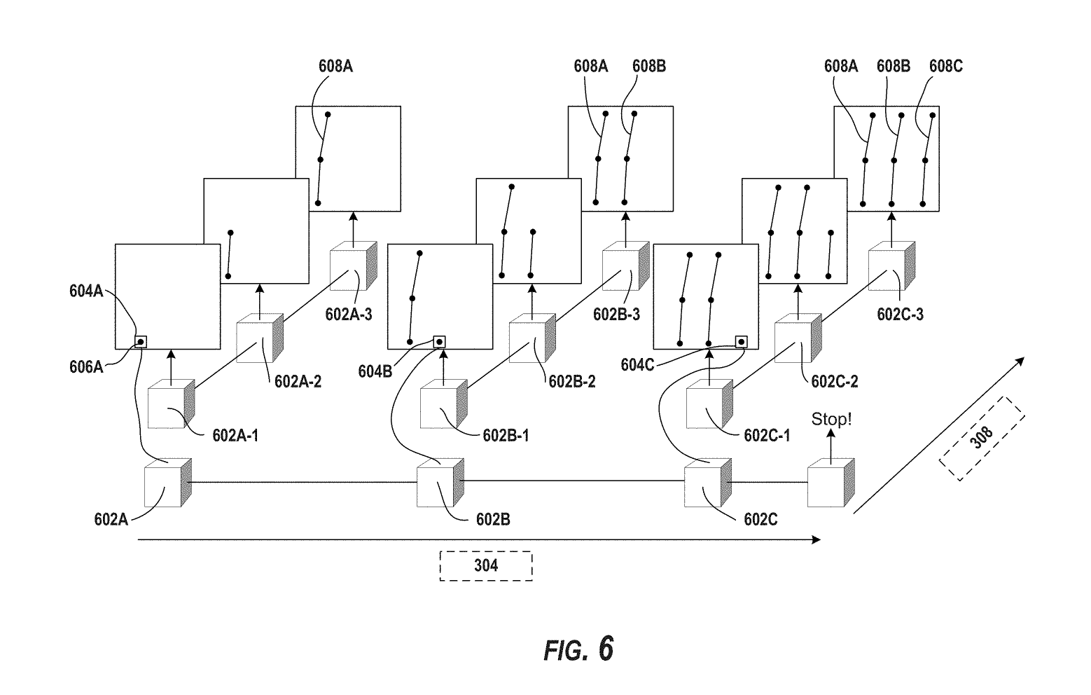

FIG. 6 depicts a diagram 600 illustrating an example process for iterative lane graph generation according to example embodiments of the present disclosure. This illustrates, for example, the overall structure of the process by which the first machine-learned model(s) 304 (e.g., a convolutional recurrent neural network) sequentially attends to the initial regions of the lane boundaries while the second machine-learned model(s) 308 (e.g., a convolutional long short-term memory recurrent neural network) fully draws out polylines indicative of the lane boundaries. Each stage shown in FIG. 6 can represent a time (e.g., time step, time frame, point in time, etc.), a stage of the process, etc. for iteratively generating the polylines. For example, as described herein, the first machine-learned model(s) 304 (e.g., the machine-learned lane boundary detection model) can identify a plurality of lane boundaries 204A-C at stages 602A-C. The first machine-learned model(s) 304 can generate an output 306 that includes data indicative of one or more regions 604A-C associated with one or more lane boundaries 204A-C. For example, the data indicative of the one or more regions associated with one or more lane boundaries can include a first region 604A associated with a first lane boundary 204A, a second region 604B associated with a second lane boundary 204B, and/or a third region 604C associated with a third lane boundary 204C. Each region 604A-C can be an initial region associated with a respective lane boundary 204A-C. For example, the first region 604A can include a starting vertex 606A for the polyline 608A (e.g., representation of the first lane boundary 204A).

The second machine-learned model(s) 308 (e.g., a convolutional long short-term memory recurrent neural network) can utilize the first region 604A to identify the starting vertex 606A and to begin to generate the polyline 608A. The second machine-learned model(s) 308 can iteratively draw a first polyline 608A as a sequence of vertices (e.g., as shown in FIG. 6). A section (e.g., of dimension H_{c}×W_{c}) around this region can be cropped from the output feature map of the decoder 506 of and fed into the second machine-learned model(s) 308 (e.g., at time 604A-1). The second machine-learned model(s) 308 can then determine (e.g., using a logistic function, softmax, etc.) a position of the next vertex (e.g., at the time 604A-2) based at least in part on the position of the first starting vertex 606A. The second machine-learned model(s) 308 can use the position of this vertex to determine the position of the next vertex (e.g., at the time 604A-3). This process can continue until the lane boundary 204A is fully traced (or the boundary of the sensor data is reached) as the first polyline 608A.

After completion of the first polyline 608A, the second machine-learned model(s) 308 (e.g., the machine-learned lane boundary generation model) can perform a similar process to generate a second polyline 608B associated with a second lane boundary 204B at times 602B-1, 602B-2, 602B-3, etc. based at least in part on the second region 604B as identified by the first machine-learned model(s) 304 (e.g., the machine-learned lane boundary detection model). After completion of the second polyline 608B, the second machine-learned model(s) 308 (e.g., the machine-learned lane boundary generation model) can perform a similar process to generate a third polyline 608C associated with a third lane boundary 204C at times 602C-1, 602C-2, 602C-3, etc. based at least in part on the third region 604C as identified by the first machine-learned model(s) 304 (e.g., the machine-learned lane boundary detection model). In some implementations, the second machine-learned model(s) 308 can be trained to generate one or more of the polylines 608A-C during concurrent time frames (e.g., at least partially overlapping time frames). The second machine-learned model(s) 308 (e.g., the convolutional long short-term memory recurrent neural network) can continue the process illustrated in FIG. 6 until the first machine-learned model(s) 304 (e.g., the convolutional recurrent neural network) signals a stop.

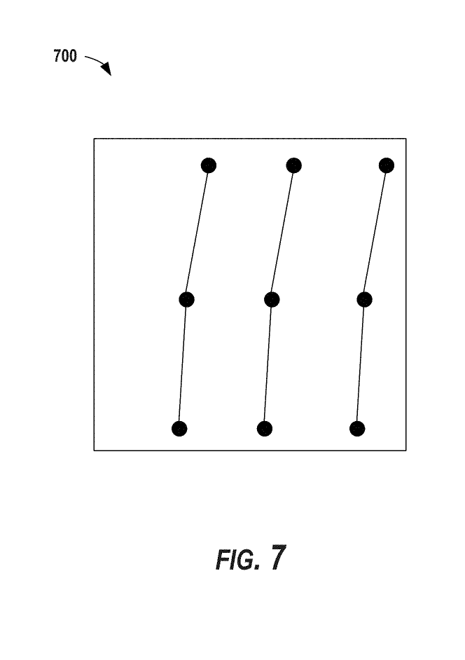

Returning to FIG. 3, the computing system 300 can output sparse geographic data 310 associated with the portion of the surrounding environment 200 of the vehicle 110. For instance, the computing system 300 can output a lane graph associated with the portion of the surrounding environment 200 of the vehicle 110 (e.g., depicted in the sensor data). An example lane graph 700 is shown in FIG. 7. The sparse geographic data 310 (e.g., the lane graph 700) can include the plurality of polylines 514A-C that are indicative of the plurality of lane boundaries 204A-C within the portion of the surrounding environment 200 of the vehicle 110 (e.g., the portion depicted in the overhead view LIDAR data). The sparse geographic data 310 (e.g., the lane graph 700) can be outputted to a memory that is local to and/or remote from the computing system 300 (e.g., onboard the vehicle 110, remote from the vehicle 110, etc.). In some implementations, the sparse geographic data 310 (e.g., the lane graph 700) can be outputted to one or more systems that are remote from an vehicle 110 such as, for example, a mapping database that maintains map data to be utilized by one or more vehicles. In some implementations, the sparse geographic data 310 (e.g., the lane graph 700) can be outputted to one or more systems onboard the vehicle 110 (e.g., positioning system 155, autonomy system 135, etc.).

With reference again to FIGS. 1 and 2, the vehicle 110 can be configured to perform one or more vehicle actions based at least in part on the sparse geographic data 310 (e.g., the lane graph 700). For example, the vehicle 110 can localize itself within its surrounding environment 200 based at least in part on the sparse geographic data 310 (e.g., the lane graph 700). The vehicle 110 (e.g., a positioning system 155) can be configured to determine a location of the vehicle 110 (e.g., within a travel lane on a highway) based at least in part on the one or more polylines 514A-C of the sparse geographic data 310 (e.g., the lane graph 700). Additionally, or alternatively, the vehicle 110 (e.g., a perception system 160) can be configured to perceive an object 202 within the surrounding environment 200 based at least in part on the sparse geographic data 310 (e.g., the lane graph 700). For example, the sparse geographic data 310 (e.g., the lane graph 700) can help the vehicle computing system 105 (e.g., perception system 160) determine that an object 202 is more likely a vehicle than any other type of object because a vehicle is more likely to be within a travel lane (between certain polylines) on a highway (e.g., than a bicycle, pedestrian, etc.). Additionally, or alternatively, the vehicle 110 (e.g., a prediction system 165) can be configured to predict a motion trajectory of an object 202 within the surrounding environment 200 of the vehicle 110 based at least in part on the sparse geographic data 310 (e.g., the lane graph 700). For example, the vehicle computing system 105 (e.g., the prediction system 165) can predict that another vehicle is more likely to travel in a manner such that the vehicle stays between the lane boundaries 204A-B represented by the polylines. Additionally, or alternatively, a vehicle 110 (e.g., a motion planning system 170) can be configured to plan a motion of the vehicle 110 based at least in part on the sparse geographic data 310 (e.g., the lane graph 700). For example, the vehicle computing system 105 (e.g., the motion planning system 170) can generate a motion plan by which the vehicle 110 is to travel between the lane boundaries 204A-C indicated by the polylines, queue for another object within a travel lane, pass an object outside of a travel lane, etc.

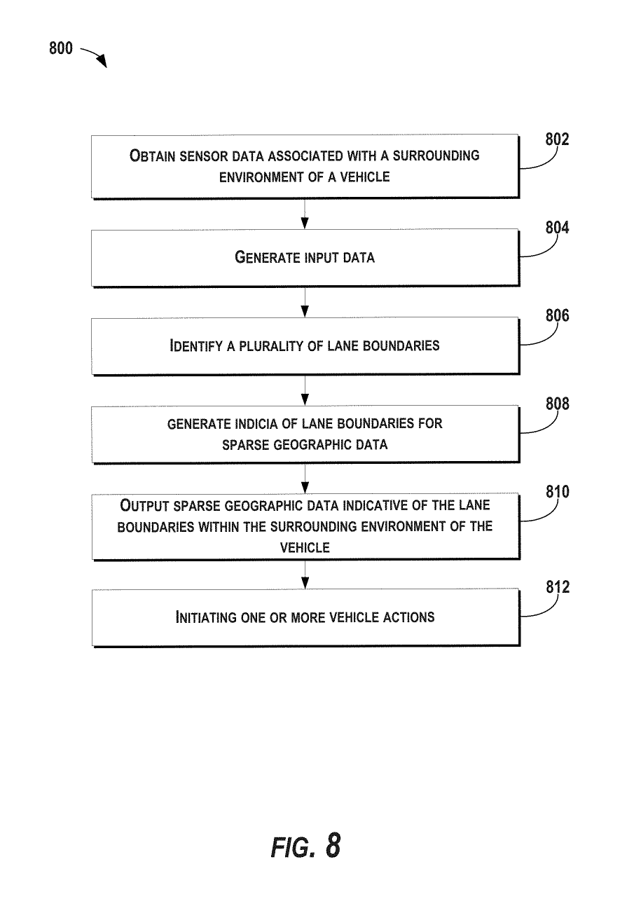

FIG. 8 depicts a flow diagram of an example method 800 of generating sparse geographic data (e.g., lane graphs, graphs indicative of other types of markings, etc.) according to example embodiments of the present disclosure. One or more portion(s) of the method 800 can be implemented by a computing system that includes one or more computing devices such as, for example, the computing systems described with reference to FIGS. 1, 3, and/or 9 and/or other computing systems (e.g., user device, robots, etc.). Each respective portion of the method 800 can be performed by any (or any combination) of one or more computing devices. Moreover, one or more portion(s) of the method 800 can be implemented as an algorithm on the hardware components of the device(s) described herein (e.g., as in FIGS. 1, 3, and 9), for example, to detect lane boundaries and/or other types of markings/boundaries (e.g., of a walkway, building, farm, etc.). FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 8 is described with reference to other systems and figures for example illustrated purposes and is not meant to be limiting. One or more portions of method 800 can be performed additionally, or alternatively, by other systems.

At (802), the method 800 can include obtaining sensor data associated with a surrounding environment of a vehicle (and/or other computing system). For instance, the computing system 300 can obtain sensor data associated with at least a portion of a surrounding environment 200 of a vehicle 110. As described herein, the sensor data can include LIDAR data associated with at least a portion of a surrounding environment 200 of a vehicle 110 (and/or other computing system) and/or other types of sensor data.

At (804), the method 800 can include generating input data. For instance, the computing system 300 can project the sensor data (e.g., LIDAR point cloud data) into a two-dimensional overhead view image (e.g., bird's eye view image). The rasterized overhead view image can depict at least a portion of the surrounding environment 200 (e.g., of the vehicle 110, other type of computing system, etc. The input data can include the overhead view image data to be ingested by a machine-learned model.

At (806), the method 800 can include identifying a plurality of lane boundaries, other types of boundaries, other markings, geographic cues, etc. For instance, the computing system 300 can identify a plurality of lane boundaries 204A-C (and/or other boundaries, markings, geographic cues, etc.) within a portion of the surrounding environment 200 (e.g., of the vehicle 110, other computing system, etc.) based at least in part on the sensor data and one or more first machine-learned model(s) 304. The first machine-learned model(s) 304 can include a machine-learned convolutional recurrent neural network and/or other types of models. The first machine-learned model(s) 304 can include machine-learned model(s) (e.g., lane boundary detection model(s)) configured to identify a plurality of lane boundaries 204A-C (and/or other boundaries, markings, geographic cues, etc.) within at least a portion of a surrounding environment 200 (e.g., of the vehicle 110, other computing system, etc.) based at least in part on input data associated with sensor data (as described herein) and to generate an output that is indicative of at least one region (e.g., region 510A) that is associated with a respective lane boundary (e.g., lane boundary 204A) of the plurality of lane boundaries 204A-C (and/or a respective other boundary, marking, geographic cue, etc.). The first machine-learned model(s) 304 can be trained based at least in part on ground truth data indicative of a plurality of training regions within a set of training data indicative of a plurality of training lane boundaries (and/or other boundaries, markings, geographic cues, etc.), as further described herein. A model can be trained to detect other boundaries, markings, geographic cues, etc. in a manner similar to the lane boundary detection model(s).

The computing system 300 can access data indicative of the first machine-learned model(s) 304 (e.g., from a local memory, from a remote memory, etc.). The computing system 300 can input a first set of input data 302 (associated with the sensor data) into the first machine-learned model(s) 304. The computing system 300 can obtain a first output 306 from the first machine-learned model(s) 304. By way of example, the first output 306 can be indicative of at least one region 510A associated with at least one lane boundary 204A (and/or other boundary, marking, geographic cue, etc.) of the plurality of lane boundaries 204A-C (and/or other boundaries, markings, geographic cues, etc.).

At (808), the method 800 can include generating indicia of lane boundaries (and/or other boundaries, markings, geographic cues, etc.) for sparse geographic data. For instance, the computing system 300 can generate (e.g., iteratively generate) a plurality of polylines 514A-C indicative of the plurality of lane boundaries 204A-C (and/or other boundaries, markings, geographic cues, etc.) based at least in part on one or more second machine-learned model(s) 308. The second machine-learned model(s) 308 can include a machine-learned convolutional long short-term memory recurrent neural network and/or other types of models. The second machine-learned model(s) 308 can be configured to generate sparse geographic data (e.g., a lane graph, other type of graph, etc.) associated with the portion of the surrounding environment 200 (e.g., of the vehicle 110, other computing system, etc.) based at least in part on at least a portion of the output 306 generated from the first machine-learned model(s) 304. The sparse geographic data (e.g., a lane graph, other type of graph, etc.) can include a plurality of polylines 514A-C indicative of the plurality of lane boundaries 204A-C (and/or other boundaries, markings, geographic cues, etc.) within the portion of the surrounding environment 200 (e.g., of the vehicle 110, other computing system, etc.). For instance, each polyline of the plurality of polylines 514A-C can be indicative of an individual lane boundary (and/or other boundary, marking, geographic cue, etc.) of the plurality of lane boundaries 204A-C (and/or other boundaries, markings, geographic cues, etc.). The second machine-learned model(s) 304 can be trained based at least in part on a loss function that penalizes a difference between a ground truth polyline and a training polyline that is generated by the second machine-learned model(s) 308, as further described herein.

The computing system 300 can access data indicative of the second machine-learned model(s) 308 (e.g., from a local memory, remote memory, etc.). The computing system 300 can input a second set of input data into the second machine-learned model(s) 308. The second set of input data can be indicative of at least one first region 510A associated with a first lane boundary 204A (and/or other boundary, marking, geographic cue, etc.) of the plurality of lane boundaries 204A-C (and/or other boundaries, markings, geographic cues, etc.). The second machine-learned model(s) 308 can be configured to identify a first vertex 512A of the first lane boundary 204A (and/or other boundary, marking, geographic cue, etc.) based at least in part on the first region 510A. The second machine-learned model(s) 308 can be configured to generate a first polyline 514A indicative of the first lane boundary 204A (and/or other boundary, marking, geographic cue, etc.) based at least in part on the first vertex 512A, as described herein. The computing system 300 can obtain a second output from the second machine-learned model(s) 308. The second output can be indicative of, for example, sparse geographic data (e.g., a lane graph, other graph, etc.) associated with the portion of the surrounding environment 200.

The second machine-learned model(s) 308 can iteratively generate other polylines. For example, the second set of input data can be indicative of at least one second region 514B associated with a second lane boundary 204B (and/or other boundary, marking, geographic cue, etc.) of the plurality of lane boundaries 204A-C (and/or other boundaries, markings, geographic cues, etc.). The second machine-learned model(s) 308 can be configured to generate a second polyline 514B indicative of the second lane boundary 204B (and/or other boundary, marking, geographic cue, etc.) after the generation of the first polyline 514A indicative of the first lane boundary 204A (and/or other boundary, marking, geographic cue, etc.).

At (810), the method 600 can include outputting sparse geographic data indicative of the lane boundaries (and/or other boundaries, markings, geographic cues, etc.) within the surrounding environment (e.g., of the vehicle, other computing system, etc.). For instance, the computing system 300 can output sparse geographic data 310 (e.g., a lane graph 700, other graph, etc.) associated with the portion of the surrounding environment 200 (e.g., of the vehicle 110, other computing system, etc.). The sparse geographic data 310 (e.g., the lane graph, other graph, etc.) can include the plurality of polylines 514A-C that are indicative of the plurality of lane boundaries 204A-C (and/or other boundaries, markings, geographic cues, etc.) within that portion of the surrounding environment 200 (e.g., of the vehicle 110, other compuing system, etc.).

In some implementations, at (812), the method 600 can include initiating one or more vehicle actions. For instance, the vehicle computing system 105 can include the computing system 300 (e.g., onboard the vehicle 110) and/or otherwise communicate with the computing system 300 (e.g., via one or more wireless networks). The vehicle computing system 105 can obtain the sparse geographic data 310 and initiate one or more vehicle actions by the vehicle 110 based at least in part on the sparse geographic data 310 (e.g., the lane graph 700). For example, the vehicle 110 can perceive one or more objects within the vehicle's surrounding environment 200 based at least in part on the sparse geographic data 310, predict the motion of one or more objects within the vehicle's surrounding environment 200 based at least in part on the sparse geographic data 310, plan vehicle motion based at least in part on the sparse geographic data 310, etc. In implementations within the context of other computing systems, the method can include initiating actions associated with the computing system (e.g., localizing the user device based on detected markings, etc.).

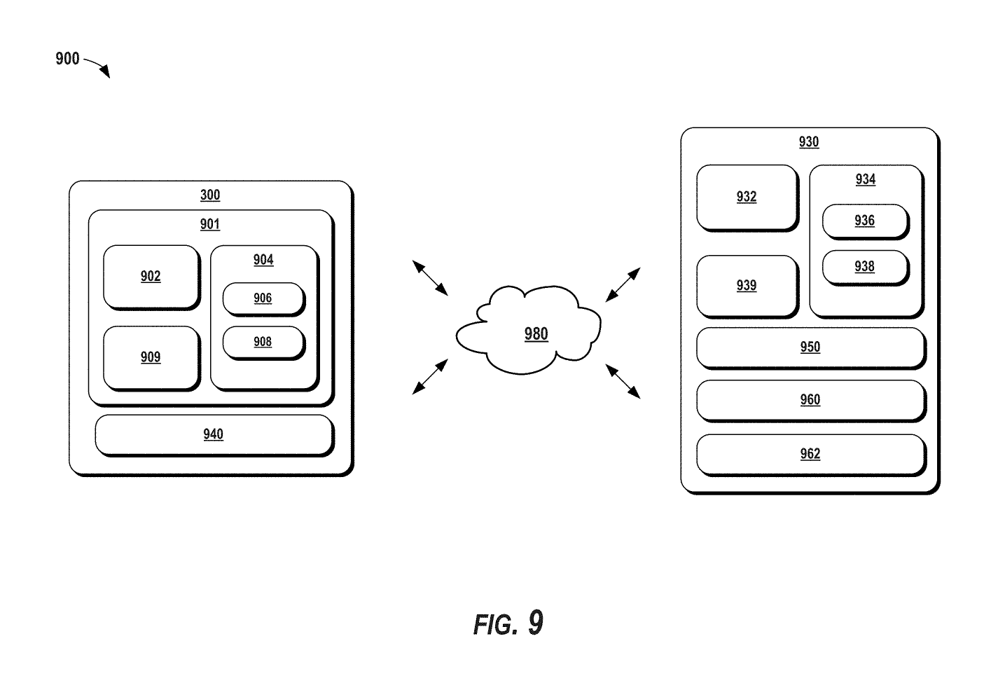

FIG. 9 depicts example system components of an example system 900 according to example embodiments of the present disclosure. The example system 900 can include the computing system 300 and a machine learning computing system 930 that are communicatively coupled over one or more network(s) 980. As described herein, the computing system 300 can be implemented onboard a vehicle (e.g., as a portion of the vehicle computing system 105) and/or can be remote from a vehicle (e.g., as portion of an operations computing system 115). In either case, a vehicle computing system 105 can utilize the operations and model(s) of the computing system 300 (e.g., locally, via wireless network communication, etc.).

The computing system 300 can include one or more computing device(s) 901. The computing device(s) 901 of the computing system 300 can include processor(s) 902 and a memory 904. The one or more processors 902 can be any suitable processing device (e.g., a processor core, a microprocessor, an ASIC, a FPGA, a controller, a microcontroller, etc.) and can be one processor or a plurality of processors that are operatively connected. The memory 904 can include one or more non-transitory computer-readable storage media, such as RAM, ROM, EEPROM, EPROM, one or more memory devices, flash memory devices, etc., and/or combinations thereof.

The memory 904 can store information that can be obtained by the one or more processors 902. For instance, the memory 904 (e.g., one or more non-transitory computer-readable storage mediums, memory devices, etc.) can include computer-readable instructions 906 that can be executed by the one or more processors 902. The instructions 906 can be software written in any suitable programming language or can be implemented in hardware. Additionally, or alternatively, the instructions 906 can be executed in logically and/or virtually separate threads on processor(s) 902.

For example, the memory 904 can store instructions 906 that when executed by the one or more processors 902 cause the one or more processors 902 (the computing system 300) to perform operations such as any of the operations and functions of the computing system 300 and/or for which the computing system 300 is configured, as described herein, the operations for identifying lane boundaries and generating sparse geographic data (e.g., one or more portions of method 800), the operations and functions of any of the models described herein and/or for which the models are configured and/or any other operations and functions for the computing system 300, as described herein.

The memory 904 can store data 908 that can be obtained (e.g., received, accessed, written, manipulated, generated, created, stored, etc.). The data 908 can include, for instance, sensor data, input data, data indicative of machine-learned model(s), output data, sparse geographic data, and/or other data/information described herein. In some implementations, the computing device(s) 901 can obtain data from one or more memories that are remote from the computing system 300.

The computing device(s) 901 can also include a communication interface 909 used to communicate with one or more other system(s) (e.g., other systems onboard and/or remote from a vehicle, the other systems of FIG. 9, etc.). The communication interface 909 can include any circuits, components, software, etc. for communicating via one or more networks (e.g., 980). In some implementations, the communication interface 909 can include, for example, one or more of a communications controller, receiver, transceiver, transmitter, port, conductors, software and/or hardware for communicating data/information.

According to an aspect of the present disclosure, the computing system 300 can store or include one or more machine-learned models 940. As examples, the machine-learned model(s) 940 can be or can otherwise include various machine-learned model(s) such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks (e.g., convolutional neural networks, etc.), recurrent neural networks (e.g., long short-term memory recurrent neural networks, etc.), and/or other forms of neural networks. The machine-learned models 940 can include the machine-learned models 304 and 308 and/or other model(s), as described herein.

In some implementations, the computing system 300 can receive the one or more machine-learned models 940 from the machine learning computing system 930 over the network(s) 980 and can store the one or more machine-learned models 940 in the memory 904 of the computing system 300. The computing system 300 can use or otherwise implement the one or more machine-learned models 940 (e.g., by processor(s) 902). In particular, the computing system 300 can implement the machine learned model(s) 940 to identify lane boundaries and generate sparse geographic data, as described herein.

The machine learning computing system 930 can include one or more processors 932 and a memory 934. The one or more processors 932 can be any suitable processing device (e.g., a processor core, a microprocessor, an ASIC, a FPGA, a controller, a microcontroller, etc.) and can be one processor or a plurality of processors that are operatively connected. The memory 934 can include one or more non-transitory computer-readable storage media, such as RAM, ROM, EEPROM, EPROM, one or more memory devices, flash memory devices, etc., and/or combinations thereof.

The memory 934 can store information that can be accessed by the one or more processors 932. For instance, the memory 934 (e.g., one or more non-transitory computer-readable storage mediums, memory devices, etc.) can store data 936 that can be obtained (e.g., generated, retrieved, received, accessed, written, manipulated, created, stored, etc.). In some implementations, the machine learning computing system 930 can obtain data from one or more memories that are remote from the machine learning computing system 930.

The memory 934 can also store computer-readable instructions 938 that can be executed by the one or more processors 932. The instructions 938 can be software written in any suitable programming language or can be implemented in hardware. Additionally, or alternatively, the instructions 938 can be executed in logically and/or virtually separate threads on processor(s) 932. The memory 934 can store the instructions 938 that when executed by the one or more processors 932 cause the one or more processors 932 to perform operations. The machine learning computing system 930 can include a communication system 939, including devices and/or functions similar to that described with respect to the computing system 300.

In some implementations, the machine learning computing system 930 can include one or more server computing devices. If the machine learning computing system 930 includes multiple server computing devices, such server computing devices can operate according to various computing architectures, including, for example, sequential computing architectures, parallel computing architectures, or some combination thereof.

In addition or alternatively to the model(s) 940 at the computing system 300, the machine learning computing system 930 can include one or more machine-learned models 950. As examples, the machine-learned models 950 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks (e.g., convolutional neural networks), recurrent neural networks (e.g., long short-term memory recurrent neural networks, etc.), and/or other forms of neural networks. The machine-learned models 950 can be similar to and/or the same as the machine-learned models 940, 304, 308.

As an example, the machine learning computing system 930 can communicate with the computing system 300 according to a client-server relationship. For example, the machine learning computing system 930 can implement the machine-learned models 950 to provide a web service to the computing system 300 (e.g., including on a vehicle, implemented as a system remote from the vehicle, etc.). For example, the web service can provide machine-learned models to an entity associated with a vehicle; such that the entity can implement the machine-learned model (e.g., to generate lane graphs, etc.). Thus, machine-learned models 950 can be located and used at the computing system 300 (e.g., on the vehicle, at the operations computing system, etc.) and/or the machine-learned models 950 can be located and used at the machine learning computing system 930.

In some implementations, the machine learning computing system 930 and/or the computing system 300 can train the machine-learned models 940 and/or 950 through use of a model trainer 960. The model trainer 960 can train the machine-learned models 940 and/or 950 using one or more training or learning algorithms. One example training technique is backwards propagation of errors. In some implementations, the model trainer 960 can perform supervised training techniques using a set of labeled training data. In other implementations, the model trainer 960 can perform unsupervised training techniques using a set of unlabeled training data. The model trainer 960 can perform a number of generalization techniques to improve the generalization capability of the models being trained. Generalization techniques include weight decays, dropouts, or other techniques.

The model trainer 960 can utilize loss function(s) can be used to train the machine-learned model(s) 940 and/or 950. The loss function(s) can, for example, teach a model when to stop counting lane boundaries. For instance, to train a machine-learned lane boundary detection model, a cross entropy loss can be applied to a region softmax output and a binary cross entropy loss can be applied on a halting probability. The model trainer 960 can train a machine-learned model 940 and/or 950 based on a set of training data 962. The training data 962 can include, for example, ground truth data (e.g., sensor data, lane graph, etc.). The ground truth for the regions can be bins in which an initial vertex of a lane boundary falls. The ground truth bins can be presented to the loss function in a particular order such as, for example, from the left of sensor data (e.g., an overhead view LIDAR image) to the right of the sensor data (e.g., the LIDAR image). For the binary cross entropy, the ground truth can be equal to one for each lane boundary and zero when it is time to stop counting the lane boundaries (e.g., in a particular overhead view LIDAR image depicting a portion of an environment of a vehicle).

A machine-learned lane boundary generation model can be trained based at least in part on a loss function. For instance, the machine-learned lane boundary generation model can be trained based at least in part on a loss function that penalizes the difference between two polylines (e.g., a ground truth polyline and a training polyline that is predicted by the model). The loss function can encourage the edges of a prediction P to superimpose perfectly on those of a ground truth Q. The following equation can be utilized for such training:

$$L ( P , Q ) = {\sum }_{i} {min}_{q ∈ Q} {‖ {p}_{i} - q ‖}_{2} + {\sum }_{j} {min}_{p ∈ P} {‖ p - {q}_{j} ‖}_{2}$$

The machine-learned lane boundary generation model can be penalized on the deviations of the two polylines. More particularly, the loss function can include two terms (e.g., two symmetric terms). The first term can encourage the training polyline that is predicted by the model to lie on, follow, match, etc. the ground truth polyline by summing and penalizing the deviation of the edge pixels of the predicted training polyline P from those of the ground truth polyline Q. The second loss can penalize the deviations of the ground truth polyline from the predicted training polyline. For example, if a segment of Q is not covered by P, all the edge pixels of that segment would incur a loss. In this way, the machine-learned lane boundary generation model can be supervised during training to accurately generate polylines. Additionally, or alternatively, other techniques can be utilized to train the machine-learned lane boundary generation model.

The above loss function can be defined with respect to all the edge pixel coordinates on P, whereas the machine-learned lane boundary generation model may, in some implementations, predict only a set of vertices. As such, for every two consecutive vertices pⱼ and pj+1 on P, the coordinates of all the edge pixel points lying in-between can be obtained by taking their convex combination. This can make the gradient flow from the loss functions to the model through every edge point. Both terms can be obtained by computing the pairwise distances, and then taking a min-pool and finally summing.

In some implementations, the model(s) 940, 950 can be trained in two stages. For example, at first stage, the encoder decoder model with only a machine-learned lane boundary generation model can be trained with training data indicative of ground truth initial regions. The gradients of the machine-learned lane boundary generation model (e.g., convolutional long short-term memory recurrent neural network) can be clipped to a range (e.g., [−10, 10], etc.) to remedy an exploding/vanishing gradient problem. For training the machine-learned lane boundary generation model, the next region can be cropped using the predicted previous vertex. The machine-learned lane boundary generation model can generate a polyline (e.g., a sequence of vertices, etc.) until the next region falls outside the boundaries of the sensor data (e.g., the boundaries of an input image, a maximum of image height divided by crop height plus a number, etc.). In some implementations, the size of the crop can be, for example, be 60×60 pixels. Training can take place with a set initial learning rate (e.g., of 0.001, etc.), weight decay (e.g., of 0.0005, etc.) and momentum (e.g., 0.9, etc. for one epoch, etc.) with a minibatch size (e.g., of 1, etc.).

Next, at a second stage, the weights of the encoder can be frozen and only the parameters of the machine-learned lane boundary detection model (e.g., convolutional recurrent neural network) can be trained (e.g., for counting for one epoch, etc.). For example, the machine-learned lane boundary detection model can be trained to predict a number of lane boundaries using an optimizer with a set initial learning rate (e.g., of 0.0005, etc.) and weight decay (e.g., of 0.0005, etc.) with a minibatch size (e.g., of 20, etc.).

In this way, the models 940/950 can be designed to output a structured representation of the lane boundaries (e.g., lane graph) by learning to count and draw polylines.

In some implementations, the training data 962 can be taken from the same vehicle as that which utilizes that model 940/950. Accordingly, the models 940/950 can be trained to determine outputs in a manner that is tailored to that particular vehicle. Additionally, or alternatively, the training data 962 can be taken from one or more different vehicles than that which is utilizing that model 940/950. The model trainer 960 can be implemented in hardware, firmware, and/or software controlling one or more processors.

The network(s) 980 can be any type of network or combination of networks that allows for communication between devices. In some embodiments, the network(s) 980 can include one or more of a local area network, wide area network, the Internet, secure network, cellular network, mesh network, peer-to-peer communication link and/or some combination thereof and can include any number of wired or wireless links. Communication over the network(s) 980 can be accomplished, for instance, via a network interface using any type of protocol, protection scheme, encoding, format, packaging, etc.

FIG. 9 illustrates one example system 900 that can be used to implement the present disclosure. Other computing systems can be used as well. For example, in some implementations, the computing system 300 can include the model trainer 960 and the training dataset 962. In such implementations, the machine-learned models 940 can be both trained and used locally at the computing system 300 (e.g., at a vehicle).

Computing tasks discussed herein as being performed at computing device(s) remote from the vehicle can instead be performed at the vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of generating lane graphs, the method comprising:
obtaining, by a computing system comprising one or more computing devices, sensor data associated with at least a portion of a surrounding environment of an autonomous vehicle;
identifying, by the computing system, a plurality of lane boundaries within the portion of the surrounding environment of the autonomous vehicle based at least in part on the sensor data and a first machine-learned model;
generating, by the computing system, a plurality of polylines indicative of the plurality of lane boundaries based at least in part on a second machine-learned model, wherein each polyline of the plurality of polylines is indicative of a lane boundary of the plurality of lane boundaries; and
outputting, by the computing system, a lane graph associated with the portion of the surrounding environment of the autonomous vehicle, the lane graph comprising the plurality of polylines that are indicative of the plurality of lane boundaries within the portion of the surrounding environment of the autonomous vehicle.

2. The computer-implemented method of claim 1, wherein identifying the plurality of lane boundaries within the portion of the surrounding environment of the autonomous vehicle comprises:
accessing, by the computing system, data indicative of the first machine-learned model;
inputting, by the computing system, a first set of input data into the first machine-learned model, wherein the first set of input data is associated with the sensor data; and
obtaining, by the computing system, a first output from the first machine-learned model, wherein the first output is indicative of at least one region associated with at least one lane boundary of the plurality of lane boundaries.

3. The computer-implemented method of claim 1, wherein iteratively generating, by the computing system, a plurality of polylines indicative of the plurality of lane boundaries based at least in part on a second machine-learned model comprises:
accessing, by the computing system, data indicative of the second machine-learned model;
inputting, by the computing system, a second set of input data into the second machine-learned model, wherein the second set of input data is indicative of at least one first region associated with a first lane boundary of the plurality of lane boundaries; and
obtaining, by the computing system, a second output from the second machine-learned model, wherein the second output is indicative of the lane graph associated with the portion of the surrounding environment.

4. The computer-implemented method of claim 3, wherein the second machine-learned model is configured to identify a first vertex of the first lane boundary based at least in part on the first region, and wherein the second machine-learned model is configured to generate a first polyline indicative of the first lane boundary based at least in part on the first vertex.

5. The computer-implemented method of claim 4, wherein the second set of input data is indicative of at least one second region associated with a second lane boundary of the plurality of lane boundaries, and wherein the second machine-learned model is configured to generate a second polyline indicative of the second lane boundary after the generation of the first polyline indicative of the first lane boundary.

6. The computer-implemented method of claim 1, wherein the first machine-learned model comprises a machine-learned convolutional recurrent neural network

7. The computer-implemented method of claim 1, wherein the second machine-learned model comprises a machine-learned convolutional long short-term memory recurrent neural network.

8. The computer-implemented method of claim 1, wherein the sensor data comprises LIDAR data associated with at least a portion of a surrounding environment of an autonomous vehicle.

9. The computer-implemented method of claim 1, wherein:
the first machine-learned model is trained based at least in part on ground truth data indicative of a plurality of training regions within a set of training data indicative of a plurality of training lane boundaries; and
the second machine-learned model is trained based at least in part on a loss function that penalizes a difference between a ground truth polyline and a training polyline that is generated by the second machine-learned model.

10. A computing system, comprising:
one or more processors; and
one or more tangible, non-transitory, computer readable media that collectively store instructions that when executed by the one or more processors cause the computing system to perform operations comprising:
obtaining sensor data associated with at least a portion of a surrounding environment of an autonomous vehicle;
identifying a plurality of lane boundaries within the portion of the surrounding environment of the autonomous vehicle based at least in part on the sensor data;
generating a plurality of polylines indicative of the plurality of lane boundaries based at least in part on a machine-learned lane boundary generation model, wherein each polyline of the plurality of polylines is indicative of a lane boundary of the plurality of lane boundaries; and
outputting a lane graph associated with the portion of the surrounding environment of the autonomous vehicle, the lane graph comprising the plurality of polylines that are indicative of the plurality of lane boundaries within the portion of the surrounding environment of the autonomous vehicle.

11. The computing system of claim 10, wherein identifying the plurality of lane boundaries within the portion of the surrounding environment of the autonomous vehicle based at least in part on the sensor data comprises:
identifying the plurality of lane boundaries within the portion of the surrounding environment of the autonomous vehicle based at least in part on a machine-learned lane boundary detection model.

12. The computing system of claim 11, wherein the machine-learned lane boundary detection model is configured to identify a number of lane boundaries within the portion of the surrounding environment based at least in part on input data associated with the sensor data.

13. The computing system of claim 12, wherein the machine-learned lane boundary detection model is configured to generate an output, wherein the output comprises data indicative of one or more regions associated with one or more lane boundaries.

14. The computing system of claim 13, wherein the machine-learned lane boundary generation model is configured iteratively generate the plurality of polylines indicative of the plurality of lane boundaries based at least in part on at least a portion of the output generated by the machine-learned lane boundary detection model.

15. The computing system of claim 14, wherein the data indicative of the one or more regions associated with one or more lane boundaries comprises a first region associated with a first lane boundary and a second region associated with a second lane boundary.

16. The computing system of claim 15, wherein the machine-learned lane boundary generation model is configured to generate a first polyline indicative of the first lane boundary based at least in part on the first region, and after completion of the first polyline, generate a second polyline indicative of the second lane boundary based at least in part on the second region.

17. A computing system, comprising:
one or more tangible, non-transitory computer-readable media that store:
a first machine-learned model that is configured to identify a plurality of lane boundaries within at least a portion of a surrounding environment of an autonomous vehicle based at least in part on input data associated with sensor data and to generate an output that is indicative of at least one region that is associated with a respective lane boundary of the plurality of lane boundaries; and
a second machine-learned model that is configured to generate a lane graph associated with the portion of the surrounding environment of the autonomous vehicle based at least in part on at least a portion of the output generated from the first machine-learned model, wherein the lane graph comprises a plurality of polylines indicative of the plurality of lane boundaries within the portion of the surrounding environment of the autonomous vehicle.

18. The computing system of claim 17, wherein the computing system is located onboard the autonomous vehicle.

19. The computing system of claim 17, wherein the computing system is not located onboard the autonomous vehicle.

20. The computing system of claim 17, wherein the autonomous vehicle is configured to perform one or more vehicle actions based at least in part on the lane graph.
